(19) United States
(12) Patent Application Publication
(10) Pub. No.: US 2013/0290852 A1
(43) Pub. Date: Oct. 31, 2013

(54) Nutrition Information System and Related Method

(71) Applicants: Matthew Silverman, Evanston, IL (US); Daniel Zadoff, Miami, FL (US)

(72) Inventors: Matthew Silverman, Evanston, IL (US); Daniel Zadoff, Miami, FL (US)

(21) Appl. No.: 13/852,093

(22) Filed: Mar. 28, 2013

Related U.S. Application Data
(60) Provisional application No. 61/640,091, filed on Apr. 30, 2012.

(51) Int. Cl. G06F 3/0484

(52) U.S. Cl. CPC G06F 3/0484
USPC 715/733

(57) ABSTRACT

A system and related method are disclosed. The system includes a user interface application configured to allow for uploading and entering nutrition information for food items and sending the uploaded information to a server; the server (including memory, data storage devices and a central processing unit) configured to receive and store the nutrition information entered by the user via the user interface application in a database maintained on the server, configured to analyze and process the nutrition information, store the processed information, and to export the information to an application programming interface comprising at least one widget configured to utilize the processed information.

### RELATED APPLICATION DATA

This application claims the priority of prior U.S. provisional application Ser. No. 61/640,091 filed on Apr. 30, 2012, which is hereby incorporated by reference herein in its entirety.

### TECHNICAL FIELD

The present invention relates generally to nutrition information systems and methods, and more specifically to systems and methods for facilitating standardized organization, publishing, and retrieval of nutrition information for food items.

### BACKGROUND ART

The prior art systems and methods do not allow food vendors to manage the nutrition information for all of the food items they carry, nor do they facilitate publishing that nutrition information in a digital format. In addition, prior art systems and methods do not sync to a centralized real-time database of nutrition data. Thus, there is a need to develop a system that allows facilitating standardized organization and publishing of nutrition information for food items.

Additionally, the prior art does not provide for a system for consumers to easily access information about food and nutrition products that presents in a clear, concise and customizable way the vast amount of information at the disposal of food/nutrition vendors about the content of the products. The prior art does not provide for a customizable system that will recognize whether a product contains an item of health risk for an individual (e.g., gluten or an allergen), or if it is appropriately sourced (vegan, vegetarian, organic) for that individual customer.

The system and associated platform of the presently claimed invention allows food vendors to manage the nutrition information for all of the food items they carry. When vendors export their information, the presently claimed system checks for standards such as FDA rounding rules, possible data entry errors based on nutrition patterns, and auto determination for potential allergens by examining ingredient lists. The system then exports data to an application programming interface (API), which is used to create customized publishing tools that allow the food vendors to seamlessly share the nutrition data with customers who require such information. This information is shared via widgets that can be incorporated into the food vendor websites, and numerous other digital applications. These widgets are of use to the vendor as a tool of supply chain management, customer service, and marketing; and to the consumer as a source of information to allow them to make the clearest and best choices for his or her health.

### SUMMARY OF THE EMBODIMENTS

It is therefore an object of the subject invention to provide an efficient, convenient and reliable system and a method that enable food vendors to manage the nutrition information for all of the food items they carry.

It is an object of the subject invention to provide a system and method that enable facilitating standardized organization and publishing of nutrition information for food items.

The invention features a system for facilitating standardized organization and publishing of nutrition information for food items as well as for organized and customizable access to that information. The system comprises a user interface configured to allow for uploading/entering nutrition information for food items and sending the uploaded information to a server; the server (including memory, data storage devices and a central processing unit) configured to receive and store the nutrition information entered by the user via the user interface application in a database maintained on the server, configured to analyze and process the nutrition information, store the processed information, and to export the information to an application programming interface comprising at least one widget configured to utilize the processed information.

According to a set of related embodiments, the user interface application can reside on a device which is able to remotely connect to the server, through a web-based network or mobile network. The user interface can be configured to allow for uploading and downloading information by scanning labels, keyword searches, or voice activated searches. The at least one widget can be an allergen menu application. The user interface application can be configured to provide for a tag classification of food items. The server may be configured to update and maintain the updated nutrition information in the database. The server can be further configured to provide data analytics or statistics as to the user. The widget can be configured to provide searchable data on where the item of interest is located, or can be purchased.

A method for facilitating standardized organization and publishing of nutrition information for food items using the system of the present invention is also disclosed. The method includes the steps of providing a user interface application; uploading and/or entering nutrition information for food items using said user interface application; storing the uploaded and/or entered nutrition information in a database on a server; analyzing and processing the nutrition information by applying data logic rules; storing the processed nutrition information in the database; and exporting the processed nutrition information to an application programming interface comprising at least one widget configured to utilize said processed information.

In a related set of embodiments, the method can further include a step of tag classifying food items before storing the uploaded and/or entered nutrition information in a database on a server. The step of applying the data logic rules can include FDA rounding to adhere to the FDA labeling requirements. The step of applying the data logic rules can include error checking for rules based on each nutrition value. The applying data logic rules can include checking and flagging for missing data values. The applying data logic rules may also include classifying ingredients of food products for known allergen matches. It can also include checking and flagging items that are kept in the database for more than a pre-determined time for updating the database. The method can further include providing data analytics or statistics as to the user preferences. The method may include providing searchable data on where the time of interest is located or can be purchased.

Other aspects, embodiments and features of the invention will become apparent from the following detailed description of the invention when considered in conjunction with the accompanying figures. The accompanying figures are schematic and are not intended to be drawn to scale. In the figures, each identical or substantially similar component that is illustrated in various figures is represented by a single numeral or notation. For purposes of clarity, not every component is labeled in every figure. Nor is every component of each embodiment of the invention shown where illustration is not necessary to allow those of ordinary skill in the art to understand the invention.

### BRIEF DESCRIPTION OF THE DRAWINGS

The preceding summary, as well as the following detailed description of the invention, will be better understood when read in conjunction with the attached drawings. For the purpose of illustrating the invention, presently preferred embodiments are shown in the drawings. It should be understood, however, that the invention is not limited to the precise arrangements and instrumentalities shown.

FIG. 1 is an overview diagram illustrating a nutrition information system according to one embodiment of the present invention.

FIG. 2 describes an example of the flow of information from the application program interface with the producers and consumers of information of the invention, in accordance with one embodiment of the present invention.

FIG. 3 is an example of an allergen menu of the present invention.

FIG. 4 is an example of an interactive nutrition menu of the present invention.

FIG. 5 is an alternative presentation of an interactive allergen menu, containing specific prepared foods.

FIG. 6 shows a selection menu for a user to customize an alert system for the interface.

FIG. 7 is an example of an output for a food item, displaying specific nutritional information for a food.

FIG. 8 is a block diagram illustrating an exemplary computer system that may be implemented as computer-readable code, according to an embodiment of the present disclosure.

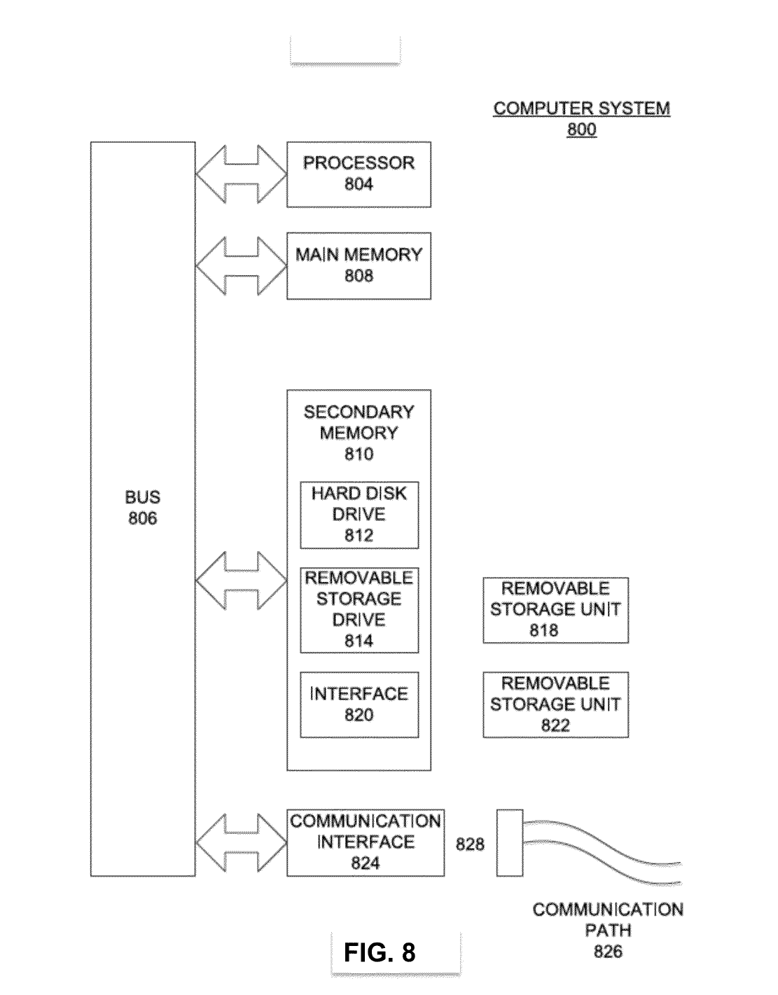

FIG. 9 is a flow diagram describing an example of the method of use of the system in accordance with one example of the present invention.

### DETAILED DESCRIPTION OF SPECIFIC EMBODIMENTS

Definitions. As used in this description and the accompanying claims, the following terms shall have the meanings indicated, unless the context otherwise requires.

A “food” or “food item” is defined as an article of commerce for consumption which provides nutritional and/or caloric content, including animal and vegetable material which is typically understood to be food, as well as nutritional supplements including, but not limited to vitamins, botanicals, herbs, minerals, fatty acids, amino acids and nutraceuticals.

A “user” of this invention is defined as any of the following: a food producer, food vendor, or food consumer, including anyone who is able to enter/edit information, or read/extract resulting information from the invention.

“Nutrition information” is defined for the purposes of this invention as any information that relates to the content of the food, including, but not limited to, ingredients, content of calories, fat, carbohydrates, vitamins, allergens, gluten, minerals, and contents of packaging that could leach into the food (e.g., BPA). FDA standards and regulations my be found on the department's website and in publications
(http://www.fsis.usda.gov/pdf/labeling_requirements_guide.pdf Section IV, p23 (hereinafter referred to as reference 1);
http://www.fda.gov/Food/GuidanceRegulation/GuidanceDocumentsRegulatoryInformation/LabelingNutrition/ucm064932.htm (hereinafter referred to as reference 2)).

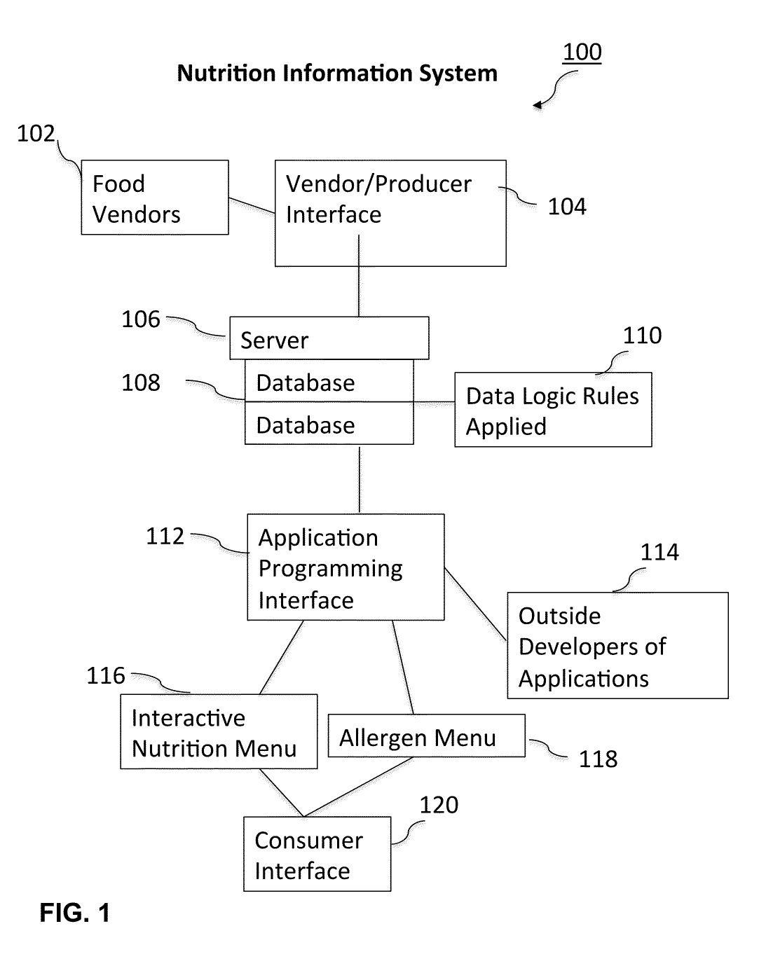

FIG. 1 is an overview diagram illustrating a nutrition information system 100 for facilitating standardized organization and publishing of nutrition information for food items in accordance with the present invention. The system 100 comprises a vendor/producer interface 104, which can be a web-based application, an application for mobile devices, or, broadly, any means of remote access to the server, database, and software which utilize the inventive process. The interface application 104 is configured to allow users to upload nutrition information for food items they carry. The nutrition information for each item may contain a list of ingredients, calories, saturated fat, and other relevant nutrition information. The system 100 further includes a server 106 having a memory, data storage devices and central processing unit. The server 106 is configured to receive and store the nutrition information entered by the food vendors 102 via the user interface application 104 in one or more databases 108 maintained on the server 106. The server 106 is also configured to analyze and process the nutrition information by applying the data logic rules 110, store the processed information, and to export this information to an application programming interface (API) 112 that comprises at least one widget configured to utilized the processed information, such as interactive nutrition menu 116 and allergen menu 118. The user interface application 104 is also configured to allow the food vendors 102 to enter the nutrition information by scanning labels on food items.

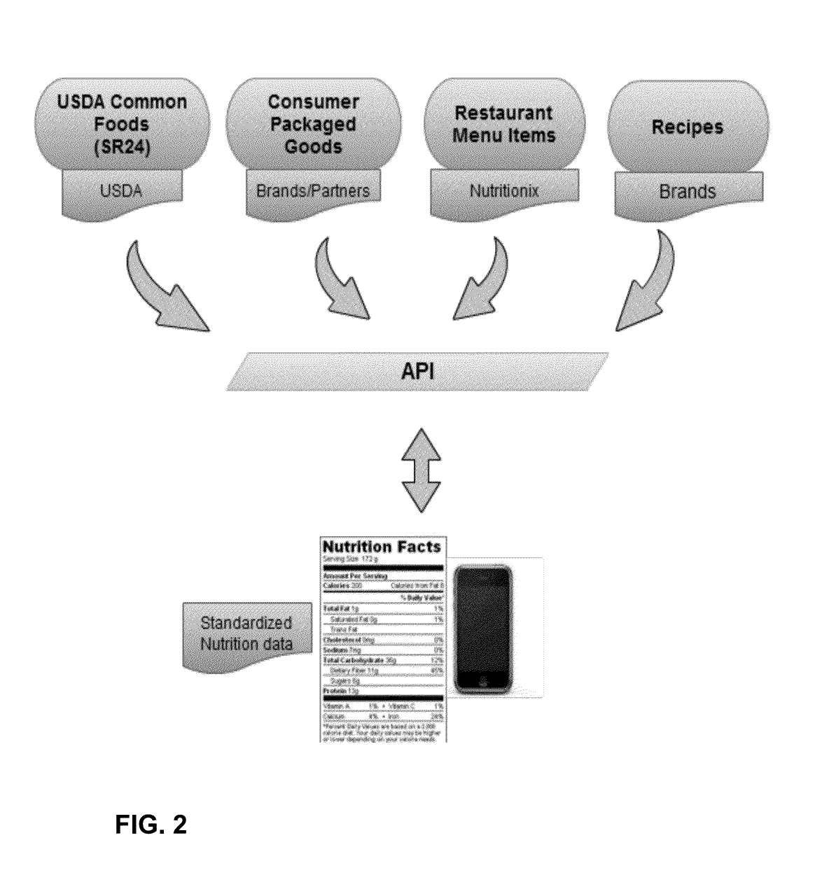

FIG. 2, is a more specific flow diagram of the information showing a flow of nutritional information from the user and FDA databases to the application program and, through the interface, output to the consumer.

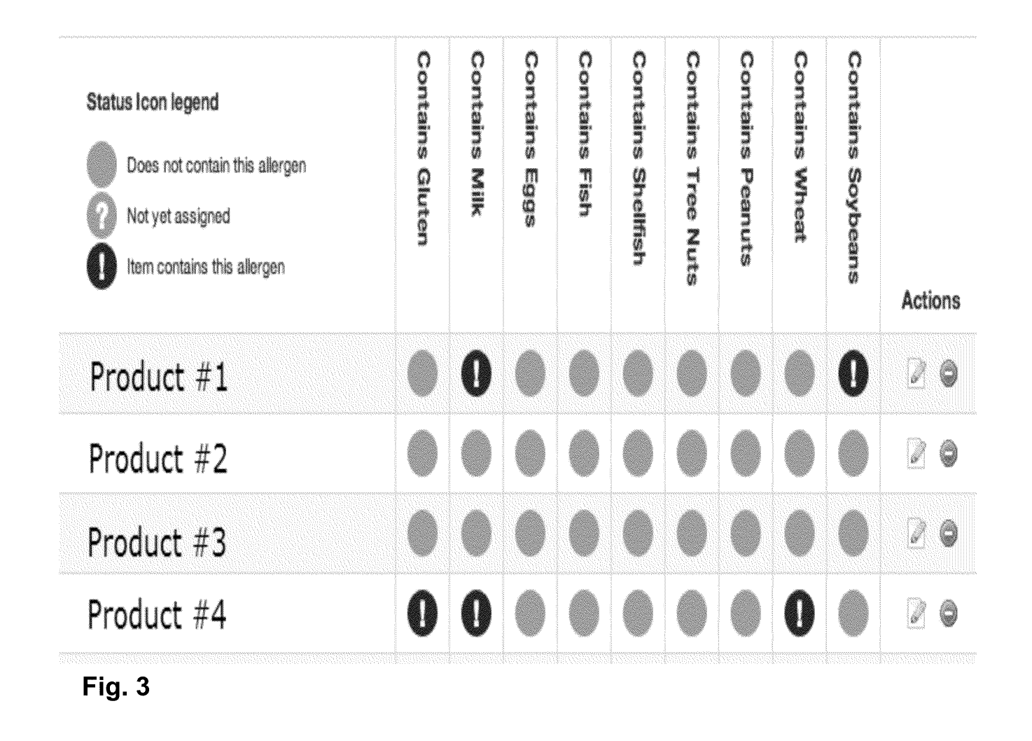

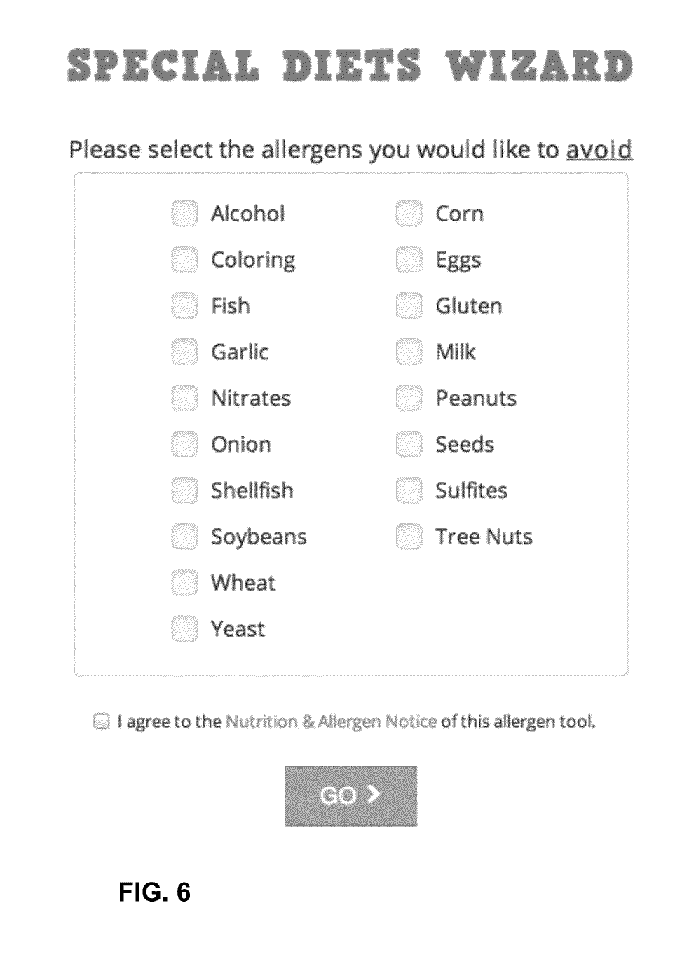

The user interface application allows the food vendors to classify food items by tagging with local tags including, but not limited to “appetizer,” “our favorite,” and with global tags including, but not limited to “gluten free,” “vegetarian,” as shown in FIG. 3. The tags can be user-defined, i.e., customizable or pre-determined, i.e. default tags. After the nutrition information has been entered and optionally tagged/classified by the user, the nutrition information data is archived in the database maintained on the server. An example of a menu of customization is shown in FIG. 6. The server is configured to process/analyze the nutrition information by applying the data logic rules such as FDA rounding to adhere to FDA labeling requirements (1) (2), error checking for rules based on each nutrition value such as calories, fat and the like (e.g., saturated fat cannot exceed total fat; sugars cannot exceed total carbs, etc). The server is configured to store/archive in the database the “raw” data as entered by the food vendors as well as to store “processed/analyzed” data after the data logic rules has been applied. The server is configured to flag the data that does not adhere to these rules. The server is further configured to process/analyze the data by checking for and flagging the missing data values. It is also configured to check for compliance of the ingredients with the tag classification entered by the food vendors. For example, lists of ingredients for each uploaded food item are analyzed for known allergen matches, and allergen tags are applied to that item automatically. For instance, if an item contains any gluten related ingredient, but the food vendor tagged the item as being “gluten-free,” the system will flag the entry and notify the vendor of a potential error. In addition, the server is configured to update the database periodically. For instance, every item uploaded into the database on the server is tracked and flagged for update by the food vendor if the item has been stored in the database for more than a pre-determined amount of time, e.g., for more than 4 months, more than 6 months, more than 12 months, etc. The system comprises at least one widget that utilizes the processed nutrition information stored in the database on the server.

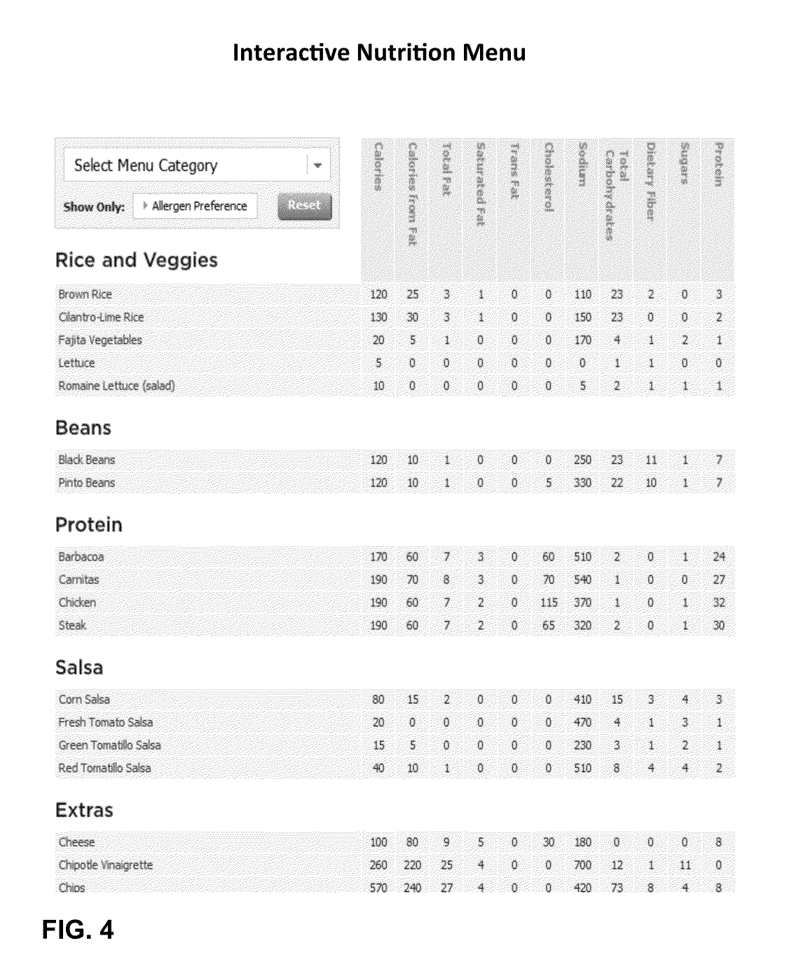

According to one embodiment of the present invention, the widget is an interactive nutrition menu as shown on FIG. 4. The user can select a particular food product of interest and apply various preference filters such as allergen, vegetarian, etc. Using this widget, the user can search for a particular food vendor, a particular product, and search for availability of particular food products that can be purchased by zip code, or other measure of proximity, such as a distance calculation from the location of the device being used to access the invention.

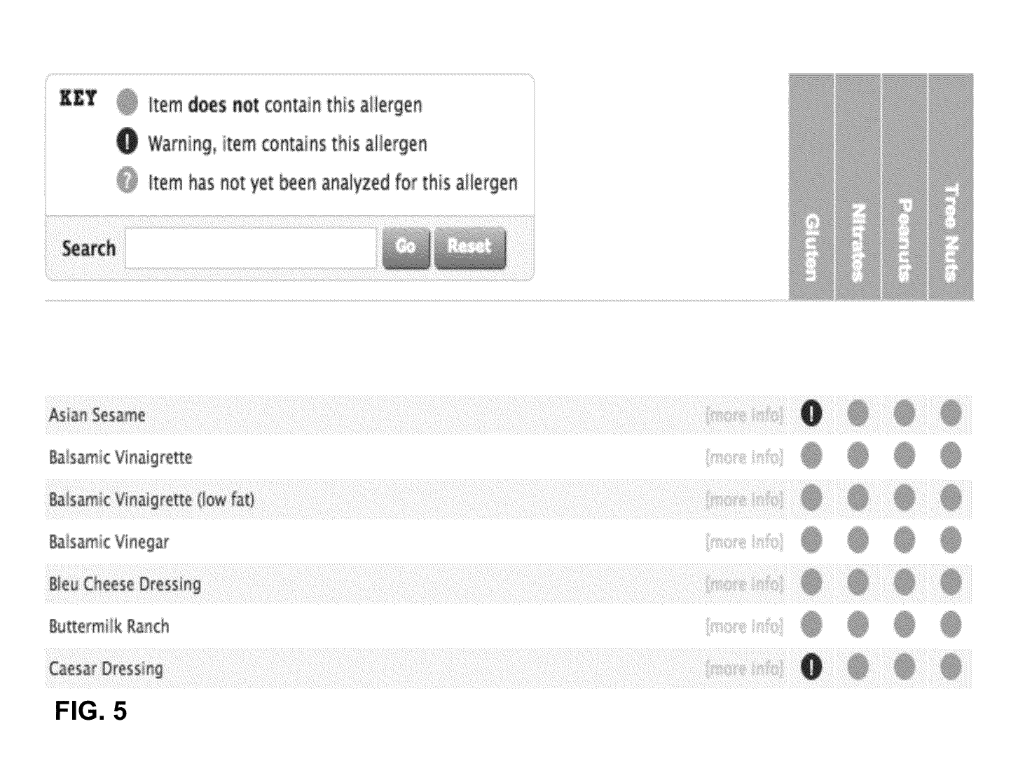

According to another embodiment of the present invention, the widget is an allergen menu as shown on FIG. 5. Using this widget, the user can select a food product of particular interest searchable by food vendor using an allergen filter. The server is also configured to analyze the nutrition information and provide statistics as to the user preferences (for example, how often users choose the “gluten free” filter when using the widgets such as nutrition menu or allergen menu). According to one embodiment of the present invention, the user interface application is one which is able to access the system of the invention and interact with the server on which the nutritional information is stored.

In one embodiment or the present invention, the user is able to access the server, database and software that provide the process of the invention by means of any remote communications, including where the communication is via the internet or mobile-based systems.

In one instance, the user interface application is configured to allow for uploading or entering nutrition information by scanning labels on food items or through keyword search.

In one embodiment of the present invention, the user interface application is configured to allow for download or retrieve of nutrition information by scanning labels or searching keywords.

In one embodiment, the user is able to interface with the server by means of a software application, which enables the user to enter data, retrieve data, sort data and merge data.

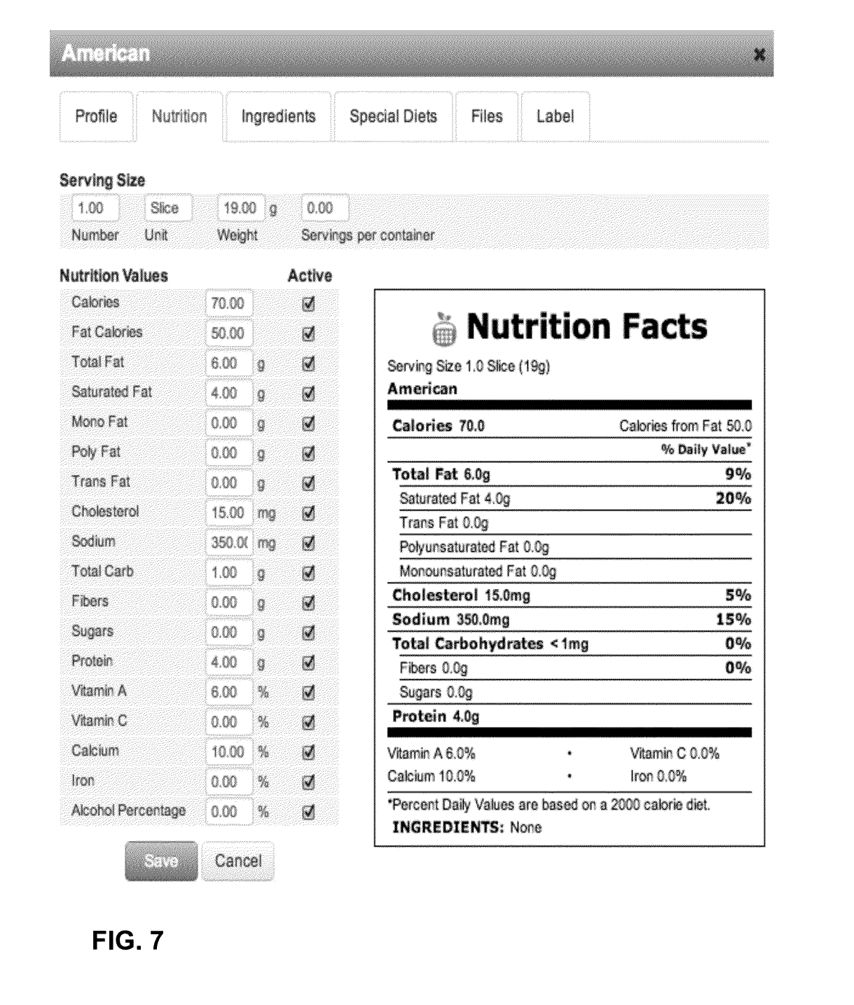

According to one variant, the widget can be an interactive nutrition menu application. FIG. 7 shows an example of the envisioned nutrition interfaces.

According to another variant, the widget is an allergen menu application.

In one instance, the user interface application is further configured to provide for a tag classification of food items. Such tags would be represented by local tags including, but not limited to “appetizer,” “our favorite,” and global tags including, but not limited to “gluten free,” “kosher,”).

According to one embodiment of the present invention, the server is configured to update and maintain the updated nutrition information in the database.

According to another embodiment, the server is further configured to provide data analytics/statistics as to the user preferences. A representative, non-limiting example of such would be the data on the number of times the user has utilized a ‘gluten free’ tag.

In one instance, at least one widget is further configured to provide searchable data on where the item of interest is located/can be purchased that can be organized proximity to the user, either via a zip code, or via the geographical location of the user.

A method for facilitating standardized organization and publishing of nutrition information for food items using the system is also disclosed. The method comprises providing a user interface application; uploading/entering nutrition information for food items using the user interface application; storing the uploaded/entered nutrition information in a database on a server; analyzing and processing the nutrition information by applying data logic rules; storing the processed nutrition information in the database; and exporting the processed nutrition information to an application programming interface comprising at least one widget configured to utilize the processed information.

According to one preferred method of the present invention, the user interface application is a web-based application.

According to another method, the user interface application is a mobile device application.

In one embodiment, the uploading/entering nutrition information is conducted by scanning labels on food items.

In one embodiment, the downloading/retrieval of information is conducted by keyword search on food items.

In one embodiment, the downloading/retrieval of information is conducted by voice activated search.

In a further embodiment, the downloading/retrieval on information is conducted by keyword search.

In a further embodiment, the downloading/retrieval on information is conducted by voice-activated search.

In one instance the widget can be an interactive nutrition menu application.

In another instance, the widget is an allergen menu application.

According to one example, the method further comprises tag classifying food items and individual ingredients before storing the uploaded/entered nutrition information in a database on a server.

According to another example, applying the data logic rules can comprise FDA rounding to adhere to FDA labeling requirements.

In one instance, applying the data logic rules can comprise error checking for rules based on each nutrition value (including, but not limited to calories, fat, gluten, nut content) as well as checking and flagging for missing data values.

In another instance, applying the data logic rules comprising classifying ingredients of food products for known allergen matches.

And yet in another instance, applying the data logic rules comprising checking and flagging items that are older than a pre-determined time for updating the database.

According to one variant of the present invention, the method further comprising the step of providing data analytics/statistics as to the user preferences (e.g., how often users choose the “gluten free” filter).

According to another variant, the method further comprising the step of providing searchable data on where the item of interest is located/can be purchased (e.g. searchable by zip code, or by distance from user).

According to one method of the present invention, the nutrition information can be uploaded by scanning labels on food items. The method allows for tag classifying food items before storing the uploaded/entered nutrition information in a database on a server. The step of applying the data logic rules includes FDA rounding to adhere to the FDA labeling requirements, error checking for rules based on each nutrition value including, but not limited to, calories, fat, (e.g., saturated fat cannot exceed total fat; sugars cannot exceed total carbs, etc), checking and flagging for missing data values, classifying ingredients for known allergen matches, checking and flagging items that are kept in the database for more than a pre-determined time for updating the database, e.g., for more than 4 months, more than 6 months, more than 12 months, etc. The method can further comprise the step of providing data analytics/statistics as to the user preferences while using the widgets (e.g., how often user/consumer chooses the “gluten free” filter, or “vegetarian” filter, etc).

If programmable logic is used, such logic may execute on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor “cores.”

Various embodiments of the invention are described in terms of this example computer system 800. After reading this description, it will become apparent to a person skilled in the relevant art how to implement embodiments of the present invention using other computer systems and/or computer architectures. Although operations operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 804 may be a special purpose or a general purpose processor device. As will be appreciated by persons skilled in the relevant art, processor device 804 may also be a single processor in a multi-core/multiprocessor system, such system operating alone, or in a cluster of computing devices operating in a cluster or server farm. Processor device 804 is connected to a communication infrastructure 808, for example, a bus, message queue, network, or multi-core message-passing scheme.

Computer system 800 also includes a main memory 808, for example, random access memory (RAM), and may also include a secondary memory 810. Secondary memory 810 may include, for example, a hard disk drive 812, removable storage drive 814. As will be appreciated by persons skilled in the relevant art, removable storage unit 818 includes a computer usable storage medium having stored therein computer software and/or data.

In alternative implementations, secondary memory 810 may include other similar means for allowing computer programs or other instructions to be loaded into computer system 800. Such means may include, for example, a removable storage unit 822 and an interface 820. Examples of such means may include a program cartridge and cartridge interface (such as that found in video game devices), a removable memory chip (such as an EPROM, or PROM) and associated socket, and other removable storage units 822 and interfaces 820 which allow software and data to be transferred from the removable storage unit 822 to computer system 800.

Computer system 800 may also include a communications interface 824. Communications interface 824 allows software and data to be transferred between computer system 800 and external devices. Communications interface 824 may include a modem, a network interface (such as an Ethernet card), a communications port, a PCMCIA slot and card. Software and data transferred via communications interface 824 may be in the form of signals, which may be electronic, electromagnetic, optical, or other signals capable of being received by communications interface 824. These signals may be provided to communications interface 824 via a communications path 828. Communications path 828 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 818, removable storage unit 822, and a hard disk installed in hard disk drive 812. Computer program medium and computer usable medium may also refer to memories, such as main memory 808 and secondary memory 810, which may be memory semiconductors (e.g. DRAMs, etc.).

Computer programs (also called computer control logic) are stored in main memory 808 and/or secondary memory 810. Computer programs may also be received via communications interface 824. Such computer programs, when executed, enable computer system 800 to implement embodiments as discussed herein. In particular, the computer programs, when executed, enable processor device 804 to implement the processes of embodiments of the present invention, such as the stages in the methods illustrated by flowcharts of FIGS. 1 and 5, discussed above. Accordingly, such computer programs represent controllers of the computer system 800. Where embodiments are implemented using software, the software may be stored in a computer program product and loaded into computer system 800 using removable storage drive 814, interface 820, and hard disk drive 812, or communications interface 824.

Embodiments of the invention also may be directed to computer program products comprising software stored on any computer useable medium. Such software, when executed in one or more data processing device, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nano-technological storage device, etc.), and communication mediums (e.g., wired and wireless communications networks, local area networks, wide area networks, intranets, etc.).

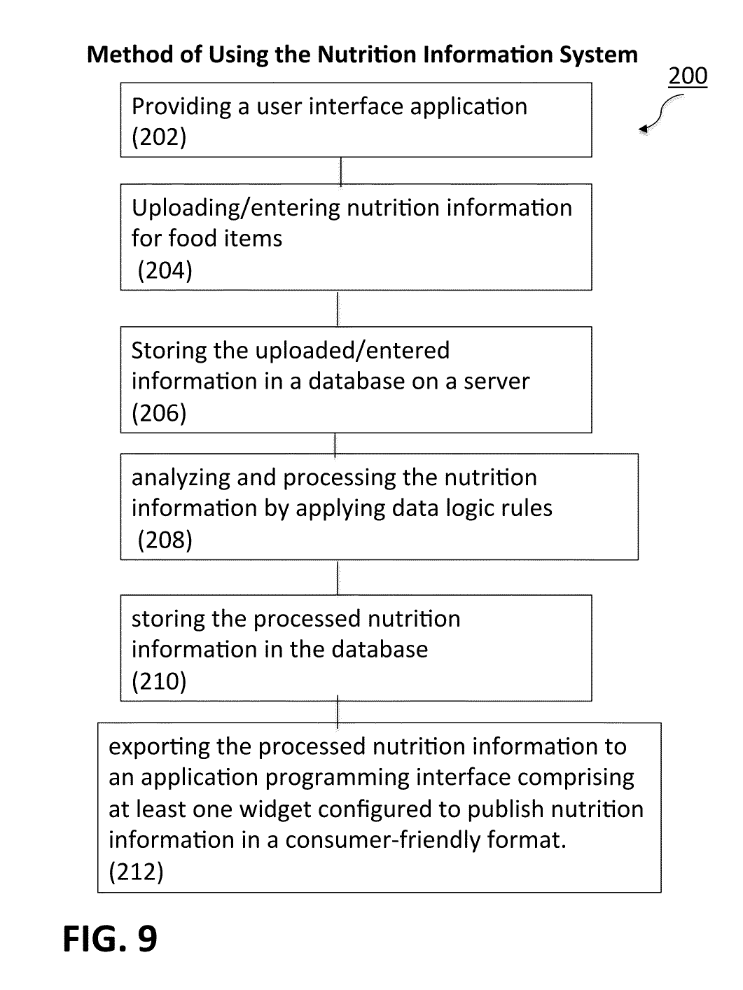

The method of using the nutrition information system for facilitating standardized organization and publishing of nutrition information for food items in accordance with one example of the present invention is shown in FIG. 9. The method 200 comprises the steps of providing a user interface application 202 (such as web-based application, or an application for mobile devices, other means of remote access to the server), uploading and/or entering nutrition information for food items 204, storing the uploaded nutrition information in a database on a server 206, analyzing and processing the nutrition information by applying data logic rules 208, storing the processed nutrition information in the database 210, and exporting the processed nutrition information to an application programming interface comprising at least one widget, such as interactive nutrition menu application or an allergen menu application, configured to utilized the processed information and to publish the nutrition information in a consumer-friendly format 212.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A system for facilitating standardized organization and publishing of nutrition information for food items, said system comprising:
a user interface application configured to allow for uploading and entering nutrition information for food items and sending the uploaded information to a server; the server (including memory, data storage devices and a central processing unit) configured to receive and store the nutrition information entered by the user via the user interface application in a database maintained on the server, configured to analyze and process the nutrition information, store the processed information, and to export said information to an application programming interface comprising at least one widget configured to utilize said processed information.

2. The system of claim 1, wherein said user interface application resides on a device which is able to remotely connect to the server, through a web-based network or mobile network.

3. The system of claim 1, wherein the user interface allows for uploading or downloading information by scanning labels, keyword searches, or voice activated search.

4. The system of claim 1, wherein at least one widget is an allergen menu application.

5. The system of claim 1, wherein the user interface application is further configured to provide for a tag classification of food items.

6. The system of claim 1, wherein the server is configured to update and maintain the updated nutrition information in the database.

7. The system of claim 1, wherein the server is further configured to provide data analytics/statistics as to the user.

8. The system of claim 1, wherein at least one widget is further configured to provide searchable data on where the item of interest is located, or can be purchased.

9. A method for facilitating standardized organization and publishing of nutrition information for food items using the system of claim 1, said method comprising:
providing a user interface application; uploading and/or entering nutrition information for food items using said user interface application; storing the uploaded and/or entered nutrition information in a database on a server; analyzing and processing the nutrition information by applying data logic rules; storing the processed nutrition information in the database; and exporting the processed nutrition information to an application programming interface comprising at least one widget configured to utilize said processed information.

10. The method of claim 9, wherein the user interface application resides on a device which is able to remotely able to connect to the server, through a web-based network or mobile network.

11. The method of claim 9, wherein the user interface allows for uploading or downloading information by scanning labels, keyword searches, or voice activated search.

12. The method of claim 9, further comprising tag classifying food items before storing the uploaded and/or entered nutrition information in a database on a server.

13. The method of claim 9, wherein applying the data logic rules comprising FDA rounding to adhere to FDA labeling requirements.

14. The method of claim 9, wherein applying the data logic rules comprising error checking for rules based on each nutrition value.

15. The method of claim 9, wherein applying the data logic rules comprising checking and flagging for missing data values.

16. The method of claim 9, wherein applying the data logic rules comprising classifying ingredients of food products for known allergen matches.

17. The method of claim 9, wherein applying the data logic rules comprising checking and flagging items that are kept in the database for more than a pre-determined time for updating the database.

18. The method of claim 9 further comprising the step of providing data analytics or statistics as to the user preferences.

19. The method of claim 9 further comprising the step of providing searchable data on where the item of interest is located or can be purchased.
